(19) United States
(12) Patent Application Publication
(10) Pub. No.: US 2012/0094515 A1
(43) Pub. Date: Apr. 19, 2012

(54) PLUG CONNECTOR HAVING AN IMPROVED LATCHING MECHANISM

(75) Inventor: JERRY WU, Irvine, CA (US)

(73) Assignee: HON HAI PRECISION INDUSTRY CO., LTD., New Taipei (TW)

(21) Appl. No.: 13/236,085

(22) Filed: Sep. 19, 2011

(30) Foreign Application Priority Data
Oct. 14, 2010 (CN) 201020561304.2

(51) Int. Cl. H01R 13/62

(52) U.S. Cl. 439/159

(57) ABSTRACT

A plug connector (100) mating with a complementary connector includes a housing (1) and a latching mechanism (4). The housing includes a base (1a) having a supporting face (1251) and a tongue portion (1b). The latching mechanism includes a latch (41) and a driver (42). The latch includes a connecting portion (413) having an inclined face (4131) inclining rearwardly downwardly and a latching portion (411) provided with a claw (4110). The driver has a pair of operating beams (4221) situated above the latch, and an operating portion (4224) connecting the operating beams and positioned between the supporting face and the inclined face. The operating portion in response to a rearward movement of the driver moves rearwardly along the supporting face and along the inclined face to lift the connecting portion together with the claw from a latched position to a released position.

### BACKGROUND OF THE INVENTION

1. Field of the Invention

The present invention generally relates to a plug connector, and more particularly to a plug connector used for high-speed signal transmission.

2. Description of Related Art

A committee called SFF is an ad hoc group formed to address storage industry needs in a prompt manner. When formed in 1990, the original goals were limited to define de facto mechanical envelopes within disk drives can be developed to fit compact computer and other small products.

U.S. Pat. No. 7,559,785 issued to Wu on Jul. 14, 2009 discloses a plug connector mating with a complementary connector. The plug connector comprises a housing, a latching mechanism having a driver and a latch assembled to the housing, and a metal shell attached to the housing. The driver has a head portion provided with a resisting portion, a shaft and a depressing portion opposite to the resisting portion relative to the shaft. The latch has a nest engageable with the resisting portion, and a latching portion provided with a pair of claws. The metal shell has a resilient beam resisting against the pressing portion of the driver. The driver is rotatable around the shaft to move the latch together with the claws between a latching position and an unlatching position, due to an engagement between the resisting portion of the driver and the nest of the latch.

The metal shell should be formed with a resilient beam resisting against the pressing portion of the driver in order to rotate the driver. The plug connector has a complicated configuration and the latching mechanism takes a difficult operation.

U.S. Pat. No. 7,134,914 issued to Wu on Nov. 11, 2006 discloses a plug connector for mating with a complementary connector. The plug connecting comprises a housing, a latching mechanism having a driver and a latch assembled to the housing, and a metal shell attached to the housing. The driver has a head portion provided with a resisting portion, and an actuator opposite to the head portion. The latch has a nest engageable with the resisting portion, a beam portion inclining rearwardly downwardly from the nest, and a latching portion provided with a pair of claws. When the actuator is pulled rearwardly, the resisting portion moves rearwardly and slides along the inclined beam portion to lift the latching portion from a latching position to a released position. The driver has a clumsy configuration and operates the latching portion in a unique way.

Hence, a plug connector having an improved latching mechanism is desired.

### BRIEF SUMMARY OF THE INVENTION

Accordingly, an object of the present invention is to provide a plug connector having a latching mechanism having a simple configuration and capable of taking an easy operation.

In order to achieve the above-mentioned object, a plug connector mating with a complementary connector comprises a housing and a latching mechanism. The housing includes a base having a supporting face and a tongue portion extending forwardly from the base for fitting with the complementary connector. The latching mechanism includes a latch and a driver. The latch includes a connecting portion having an inclined face inclining rearwardly downwardly and a latching portion provided with a claw. The driver has a pair of operating beams situated above the latch, and an operating portion connecting the operating beams and positioned between the supporting face and the inclined face. The operating portion in response to a rearward movement of the driver moves rearwardly along the supporting face and along the inclined face to lift the connecting portion together with the claw from a latched position to a released position.

It is easy to drive the latching mechanism to perform the latching and releasing operation, if only rearwardly pulling the driver or releasing the driver. The pair of operating beams could be designed to have a smaller width as desired. The latching mechanism has a simple light configuration.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled perspective view of a plug connector in accordance with the present invention;

FIG. 2 is a partially exploded perspective view of the plug connector as shown in FIG. 1, with a metal shell being separated;

FIG. 3 is a partially exploded perspective view of the plug connector as shown in FIG. 1, with the metal shell and a latching mechanism being separated;

FIG. 4 is a perspective view of the latching mechanism as shown in FIG. 3;

FIG. 5 is a cross-sectional view taken along line 5-5 of FIG. 1, when a latching mechanism is positioned in a latched position; and

FIG. 6 is a cross-sectional view taken along line 5-5 of FIG. 1, when the latching mechanism is positioned in a released position.

### DETAILED DESCRIPTION OF THE INVENTION

Reference will now be made to the drawing figures to describe the present invention in detail.

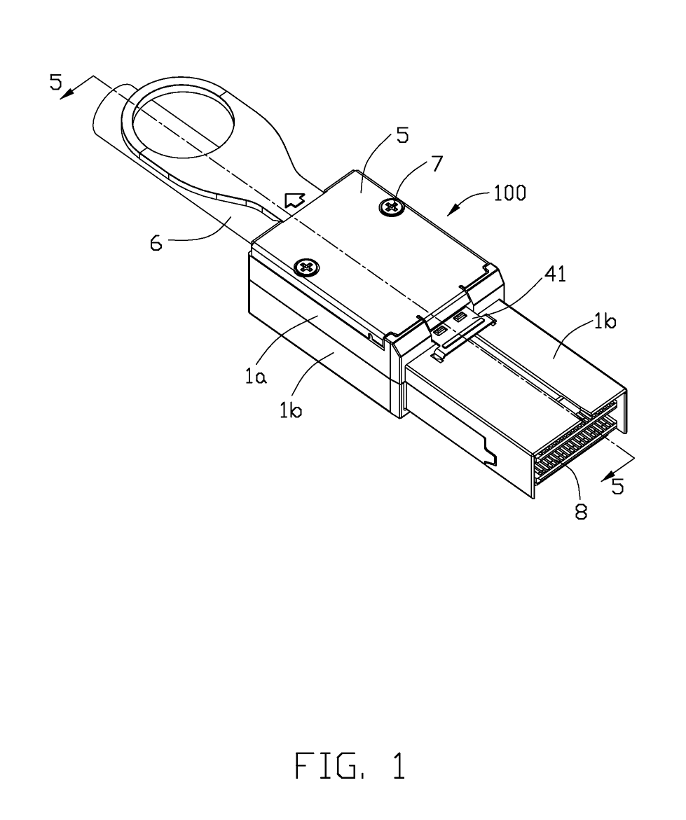

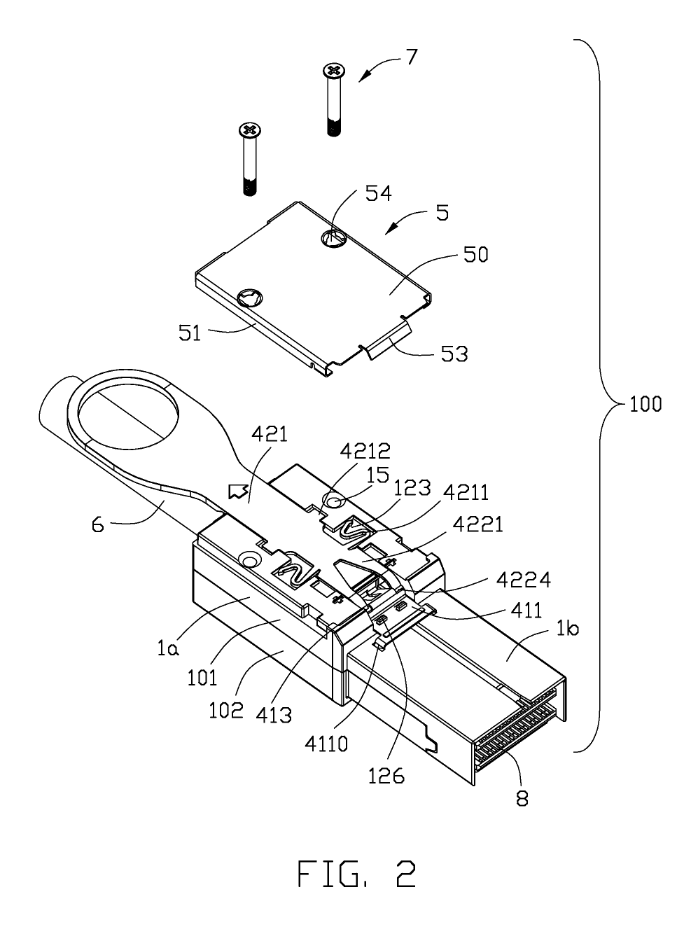

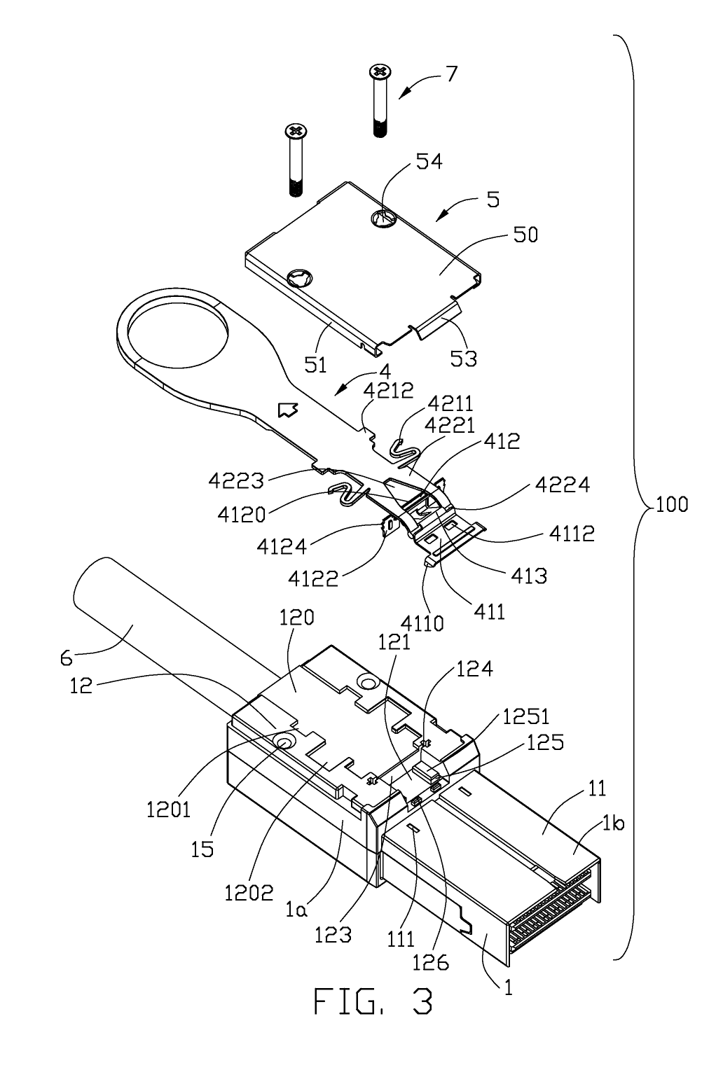

Referring to FIGS. 1-6, a plug connector 100 mating with a complimentary connector (not shown) in accordance with the present invention comprises a housing 1, a latching mechanism 4 assembled to the housing 1, a metal shell 5 attached to the housing 1 and partially covering the latching mechanism 4, a plurality of screws 7 fixing the metal shell 5 on the housing 1, a pair of circuit boards 8 disposed in the housing 1, and a cable 6 electrically connected to the circuit boards 8. If desired, the cable 6 can be replaced by other suitable structures or interfaces.

Referring to FIGS. 1-3, the housing 1 comprises a base 1a and an elongated tongue portion 1b extending forwardly from the base 1a. The base 1a comprises an upper portion 101 and a lower portion 102 engaging with each other to define a receiving space (not shown) therebetween for partially retaining the circuit boards 8 and the cable 6 in a common manner. Both upper portion 101 and lower portion 102 are preferably die-casted.

The base 1a has a top face 12. The top face 12 has a concave portion 120, and a receiving recess 121 at a level lower than the concave portion 120 to form a vertically extending resisting wall 123 disposed adjacent to the concave portion 120 and facing the receiving recess 121. The concave portion 120 defines a pair of ear recesses 1201, a pair of retaining recesses 1202 in front of the ear recesses 1201, and a pair of downwardly extending screw holes 15. The base 1a further has a pair of supporting portions 125 disposed at opposite sides of the receiving recess 121, a pair of securing slots 124 substantially aligned with the resisting wall 123, and a pair of protrusions 126 formed at a front edge of the receiving recess 121. The supporting portions 125 have the flat upper surfaces thereof performed as a supporting face 1251 extending along a front-to-back direction and at a level lower than the concave portion 120.

The tongue portion 1b has an upper face 11 at a level lower than the top face 12. The upper face 11 defines a pair of latching slits 111.

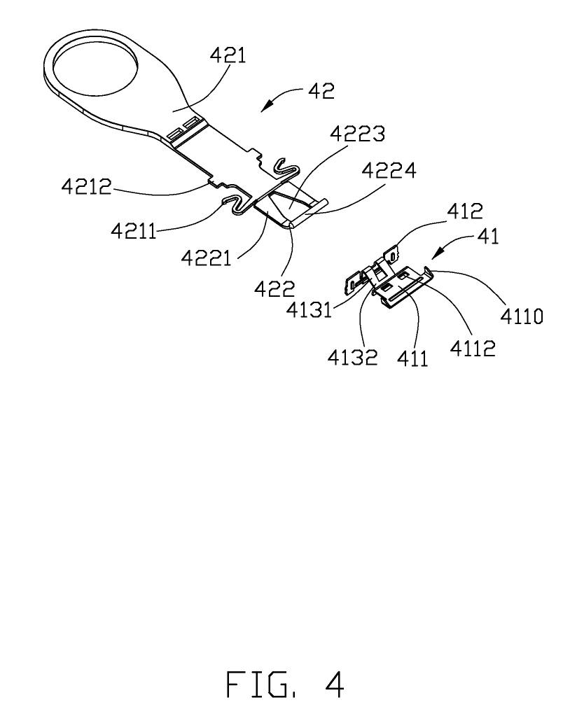

In conjunction with FIG. 4, the latching mechanism 4 comprises a latch 41 and a driver 42 assembled to the latch 41. The latch 41 is made of metal material and is formed into a cantilever-type. The latch 41 comprises a transverse bar section 412 located in a vertical surface, a flat latching portion 411 located in a horizontal surface perpendicular to the vertical surface and an inclined connecting portion 413 connecting the bar section 412 and the latching portion 411.

The bar section 412 has a body portion 4120, a pair of securing portions 4122 formed at opposite sides of the body portion 4120. Each securing portion 4122 is formed with a plurality of click portions 4124 on outmost edge thereof.

The flat latching portion 411 defines a pair of rectangular engaging holes 4112, and a pair of claws 4110 bending downwardly from opposite sides of the front edge of the latching portion 411 for clasping the complementary connector.

The connecting portion 413 has a nest 4132 disposed at a connection between the connection portion 413 and the latching portion 411, and an inclined face 4131 inclining downwardly from the nest 4132 to a lower edge of the bar section 412. The connecting portion 413 also defines a hole therein for adjusting spring force of the latch 41 through changing size and shape of the hole.

The driver 42 comprises an actuator 421 and an operator 422. The actuator 421 comprises a pair of ear portions 4212 and a pair of resilient portions 4211 in front of the ear portions 4212. Each resilient portion 4211 is S-shaped and has a free end connected with the actuator 421.

The operator 422 includes a pair of operating beams 4221 separated from each other to define an opening 4223 between the pair of operating beams 4221, and an operating portion 4224 connected with front ends of the pair of operating beams 4221.

The metal shell 5 comprises a flat top wall 50, a pair of L-shaped side walls 51 extending from opposite side edges of the top wall 50, a front flange 53 extending from a front edge of the top wall 50, and a pair of mounting holes 54 defined in the top wall 50.

Referring to FIGS. 1-5, in assembling of the plug connector 100, the cable 6 is soldered to the circuit board 8. The circuit board 8 together with the cable 6 is partially sandwiched between the upper and lower portions 101, 102. The driver 42 is mounted in concave portion 120, with the ear portions 4212 received in the ear recesses 1201 and the resilient portions 4211 plunged in the retaining recesses 1202.

The latch 41 is inserted in the receiving recess 121, with the operating portion 4224 of the driver 42 supported by the supporting portions 125 and positioned in the nest 4132 of the latch 41, and the connecting portion 413 located between the pair of supporting portions 125. The operating beams 4221 are supported on the bar section 412. The securing portions 4122 are secured in the securing slots 124, with the click portions 4124 engaging with the securing slots 124 and the body portion 4120 resisting against the resisting wall 123. The pair of engaging holes 4112 engage with the pair of protrusions 126.

The metal shell 5 is fixed on the housing 1, with the screws 7 inserted through the mounting holes 53 into the screw holes 15.

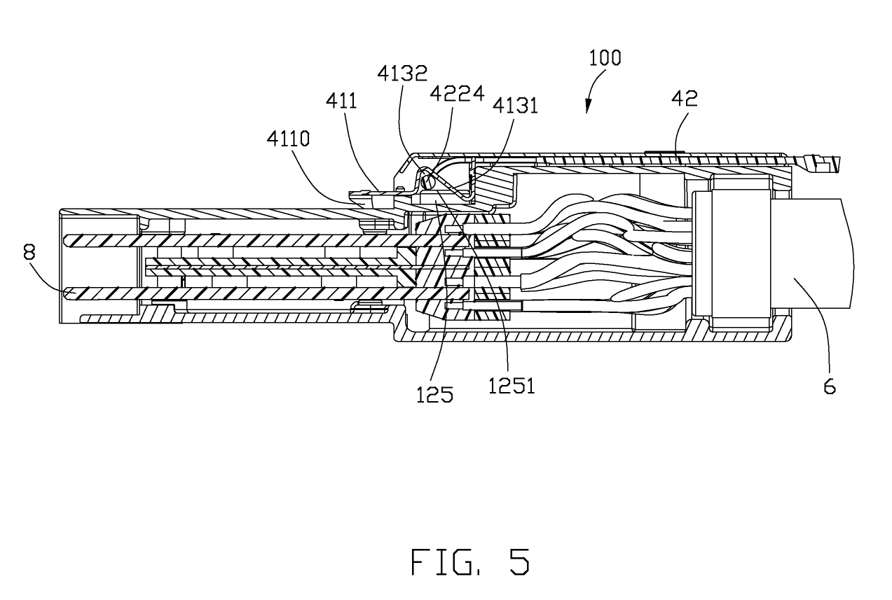

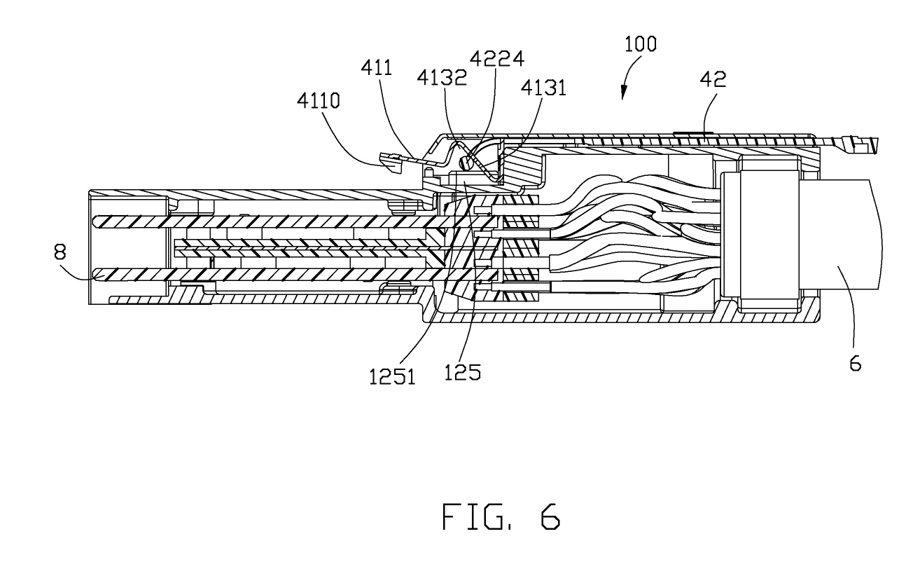

FIG. 5 illustrates the plug connector 100 located in a latched position and FIG. 6 illustrates the plug connector 100 located in a released position. When the driver 42 is pulled rearwardly, the operating portion 4224 slides rearwardly along the supporting faces 1251 of the supporting portions 125. At the same time, the operating portion 4224 leaves away from the nest 4132 and slides along the inclined face 4131 to lift the connecting portion 413. The connecting portion 413 together with the claws 4110 move upwardly from the latched position to the released position. The resilient portions 4211 are compressed in the retaining recesses 1202. The ear portions 4212 are movable in the ear recesses 1201 along the front-to-back direction to prevent the driver 42 from dropping.

When the plug connector 100 is located in the released position as shown in FIG. 6, the complementary connector could be mounted onto or removed from the plug connector 100. When the driver 3 is released, the resilient portions 4211 would restore themselves from the released position to the latched position. The latching mechanism 4 revert to the latched position as shown in FIG. 5.

When the driver 42 is pulled rearwardly, the latch 41 would be driven from the latched position to the released position automatically. When the driver 42 is released, the driver 42 would restore to the initial position automatically. It is easy to drive the latching mechanism 4 to perform the latching and releasing operation, if only pulling the driver 42 or releasing the driver 42. Additionally, the claws 4110 would latch the complementary connector reliably, since the latch 41 restores itself to the latched position via the resilient restoring force provided by the resilient portions 4211. The latching mechanism 4 has a simple configuration and is capable to take an easy operation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector adapted for mating with a complementary connector, comprising:
a housing comprising a base having a supporting face and a tongue portion extending forwardly from the base for fitting with the complementary connector; and
a latching mechanism assembled to the base and comprising:
a latch including a connecting portion having an inclined face inclining rearwardly downwardly and a latching portion provided with a claw; and
a driver comprising an operating portion, and a pair of operating beams situated above the latch, the operating portion being connected with the pair of operating beams and positioned between the supporting face and the inclined face, wherein said operating portion in response to a rearward movement of the driver moves rearwardly along the supporting face and along the inclined face to lift the connecting portion together with the claw from a latched position to a released position.

2. The plug connector as claimed in claim 1, wherein said base of the housing defines a receiving recess for positioning the latch.

3. The plug connector as claimed in claim 2, wherein said connecting portion has a nest disposed at a connection between the connection portion and the latching portion for accommodating with the operating portion in the latched position.

4. The plug connector as claimed in claim 2, wherein said base of the housing has a pair of supporting portions disposed in the opposite sides of the receiving recess, said supporting face constituted by upper surfaces of the supporting portions and extending along a front-to-back direction, said connecting portion being located between the pair of supporting portions.

5. The plug connector as claimed in claim 2, wherein said base of the housing has a concave portion rearwardly of the receiving recess, and the driver comprises an actuator positioned in the concave portion.

6. The plug connector as claimed in claim 5, wherein said concave portion is at a level higher than the receiving recess to form a vertically extending resisting wall adjacent to the concave portion and facing the receiving recess and a pair of securing slots substantially aligned with the resisting wall, said latch including a bar section having a body portion resisting against the resisting wall and a pair of securing portions secured in the securing slots.

7. The plug connector as claimed in claim 6, wherein said pair of operating beams are separated from each other to define an opening therebetween and are supported on the bar section, said operating portion connected with front ends of the pair of operating beams.

8. The plug connector as claimed in claim 6, wherein said inclined face extends downwardly rearwardly from the nest to a lower edge of the bar section.

9. The plug connector as claimed in claim 5, wherein said concave portion defines a pair of retaining recesses, and said actuator has a pair of resilient portions compressibly retained in the retaining recesses.

10. The plug connector as claimed in claim 9, wherein each resilient portion is S-shaped and has a free end connected with the actuator.

11. The plug connector as claimed in claim 5, wherein said concave portion defines a pair of ear recesses, and the actuator has a pair of ear portions moveable in the pair of ear recesses along a front-to-back direction.

12. The plug connector as claimed in claim 2, wherein said base of the housing has a pair of protrusions formed at a front edge of the receiving recess, and said latching portion defines a pair of engaging holes engaging with the protrusions in the latched position.

13. The plug connector as claimed in claim 1, wherein the claw extends downwardly from the latching portion, and said tongue portion is formed with a latching slit corresponding to the claw.

14. The plug connector as claimed in claim 1, further comprising a metal shell attached to the base for partially covering the latching mechanism.

15. A plug connector comprising:
a housing defining an inner side with a mating port therein and an outer side with a horizontal supporting face thereon;
a latch mounted to the outer side in a cantilevered manner for up and down deflection between an inner locking position and an outer releasing position, and defining a rearward inclined face with a claw at a front end;
a driver for back and forth moveable relative to the housing between a front relaxed position and a rear tensioned position respectively corresponding to the inner locking position and the outer releasing position of the latch, including a rear actuator for manual handling and a front operator interlinked to the latch, said operator defining an operating portion constantly tightly sandwiched at an inner side of an acute intersection angle between the inclined face and the supporting face disregarding the front relaxed position or the rear tensioned position of said driver.

16. The plug connector as claimed in claim 15, wherein the driver is equipped with a resilient mechanism to provide restoration force to urge the driver to move from the rear tensioned position to the front relaxed position.

17. The plug connector as claimed in claim 15, wherein said operating portion is a horizontal transverse bar having a first section and a second section at different axial positions of said bar under condition said first section constantly abuts against the supporting face while said second section constantly abuts against the inclined face.

18. The plug connector as claimed in claim 17, wherein the operator includes a pair of operating beams connected to the operating portion under condition that the inclined face is essentially located transversely between said pair of operating beams.

19. The plug connector as claimed in claim 15, further including a metallic shell attached to the outer face to cover a portion of the actuator.

20. The plug connector as claimed in claim 19, wherein said metallic shell further covers a portion of the latch.
